(19) United States
(12) Patent Application Publication
(10) Pub. No.: US 2001/0055348 A1
(43) Pub. Date: Dec. 27, 2001

(54) Sequential quadrant demodulation of digitally modulated radio signals

(76) Inventors: Christopher L. Anderson, Cincinnati, OH (US); Jeffrey W. Marshall, Batavia, OH (US); Greg Casavant, Withamsville, OH (US)

Correspondence Address: FROST BROWN TODD, LLC, 2200 PNC CENTER, 201 E. FIFTH STREET, CINCINNATI, OH, 45202, US

(21) Appl. No.: 09/798,808

(22) Filed: Mar. 2, 2001

Related U.S. Application Data
(60) Provisional application No. 60/193,930, filed on Mar. 31, 2000.

(51) Int. Cl. H04L 27/14

(52) U.S. Cl. 375/324

(57) ABSTRACT

This invention relates generally to a system and method for extracting data from a modulated signal, and more particularly to a system and method of demodulating constant-amplitude/continuous-phase digital radio modulated signals in a radio receiver. The data symbols are detected by establishing a complex trajectory of the modulated signal and interpreting the direction of the trajectory of the modulated signal as the digital data symbols. The invention has particular application to FSK-type modulated signals and more generally to π/n modulated signals.

This invention relates generally to a system and method for extracting data from a modulated signal. More particularly, the invention relates to a unique method of demodulating constant-amplitude/continuous-phase digital radio modulated signals in a radio receiver. As used herein, digital radio refers to data communications through the use of radio circuits and a free-space propagation medium. Digital radio modulation refers to a method of manipulating the characteristics of a radio frequency carrier in order to transmit digital data information (logical 1 or logical 0). Digital radio demodulation refers to a method of recovering digital data through the use of radio receiver circuits from radio signals originating from a digital radio transmitter with a corresponding modulation type.

As will be described hereinafter, the present invention is believed to be applicable to any continuous phase, constant envelope modulation scheme, including that class of linear modulations whose amplitude does not vary with time and whose phase is constantly changing. In the complex mapping, this type of modulation produces signals whose trajectory can be represented as a circle of constant radius centered around the origin for signals of constant power. The present invention has particular application to FSK (frequency shift keying)-type modulation signals, and more particularly to binary frequency shift keying (BFSK)-type modulation signals, i.e., linear digital radio modulation whereby distinct frequencies are defined to represent data symbols (e.g., logical 1 represented by frequency F1 and logical 0 represented by frequency F2). As is well known in the art, in its simplest form, BFSK-type modulation does not require a coherent receiver for demodulation.

The present invention also has application to data recovery from π/n-type modulated signals, i.e., signals where the modulation produces a trajectory in the complex plane of arc length π/n, where n is any number.

### DESCRIPTION OF THE DRAWINGS

FIG. 1 is a general block diagram of an exemplary embodiment of the present invention.

FIG. 2 is a graphical representation of the four quadrants of the I/Q plane.

FIG. 3 is a graphical representation of the signal trajectory in the I/Q plane.

FIG. 3a is a graphical representation of the signal trajectory in the I/Q plane illustrating an exemplary data symbol sequence 1101 for 2π modulation.

FIG. 3b is a graphical representation of the signal trajectory in the I/Q plane illustrating an exemplary data symbol sequence 1101 for π/2 modulation.

FIG. 4 is a block diagram of a specific exemplary implementation of the present invention.

FIG. 5 represents the VHDL code for a first embodiment of the present invention.

FIG. 6 represents the VHDL code for a second embodiment of the present invention.

FIG. 7 is a block diagram of the demodulator portion of a second exemplary embodiment of the present invention.

### DESCRIPTION AND SUMMARY OF INVENTION

The sequential quadrant detection method of the present invention performs the final signal processing of the demodulated digital radio signals to detect the transmitted data symbols. For purposes of a first exemplary showing, the present invention will be described in connection with an FSK-type modulated signal containing data symbols.

FIG. 1 illustrates a block diagram of a portion of a first exemplary embodiment of the present invention. As illustrated in FIG. 1, the received digital radio signals from antenna 1 and RF/IF stage 2 are applied to a linear vector demodulator 10. For purposes of an exemplary showing, linear vector demodulator 10 may be a RF Micro Devices model RF2711. As is well understood in the art, linear vector demodulator 10 is supplied with a local oscillator signal 11 from free-running local oscillator 12. The local oscillator signal 11 is not externally locked in phase to the RF/IF carrier input. Accordingly, a coherent detector or demodulator, i.e., a radio receiver circuit that attempts to estimate the original characteristics of the transmitter's radio carrier frequency in order to provide a reference for making demodulation decisions (e.g., logical 1 or logical 0), is not required in connection with the present invention.

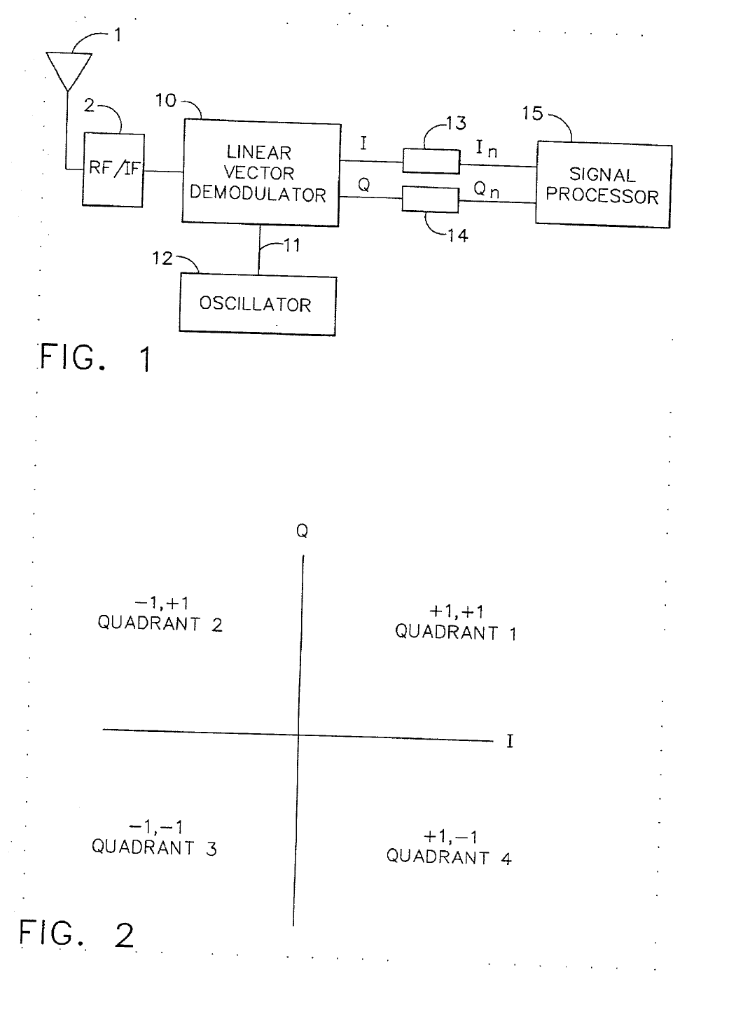

Linear vector demodulator 10 produces an in-phase (I) and a quadrature (Q) ordered pair which represents a single point on the complex I-Q plane, as depicted in FIG. 2. As is well known in the art, this type of complex representation or quadrature representation represents a transcendental mathematical description of linear signals that maps all possible modulation states to in-phase (I) and quadrature (Q) components. These I and Q components can be represented as a classical two-dimensional mapping (Cartesian mapping).

As shown in FIG. 2, the location of this point in the complex I-Q plane is determined by the amplitudes of the demodulated I signal and the demodulated Q signal with respect to a fixed reference signal, as will be described. For example, a point located in quadrant 1 of the complex plane may be represented by the coordinates (+1, +1).

In the first exemplary embodiment of the present invention, the in-phase I and quadrature Q signals from linear vector demodulator 10 are applied respectively to comparators 13 and 14 and compared against a fixed voltage reference to determine whether the I and Q signals are positive or negative. For example, for purposes of an exemplary showing, the fixed voltage reference may be 1.5 volts. In this case, the outputs Iₙ and Qₙ, respectively, from comparators 13 and 14 will be a negative value if the associated input is less than 1.5 volts, and will be a positive value if the associated input is greater than 1.5 volts. It will be understood, however, that other reference levels may be utilized within the scope of the present invention. In the exemplary embodiment described, it is the polarity of each of the I signals and the Q signals with respect to the reference signal of each of the comparators which is of importance to the present invention, whether or not the absolute amplitudes of the I and Q signals are taken into consideration.

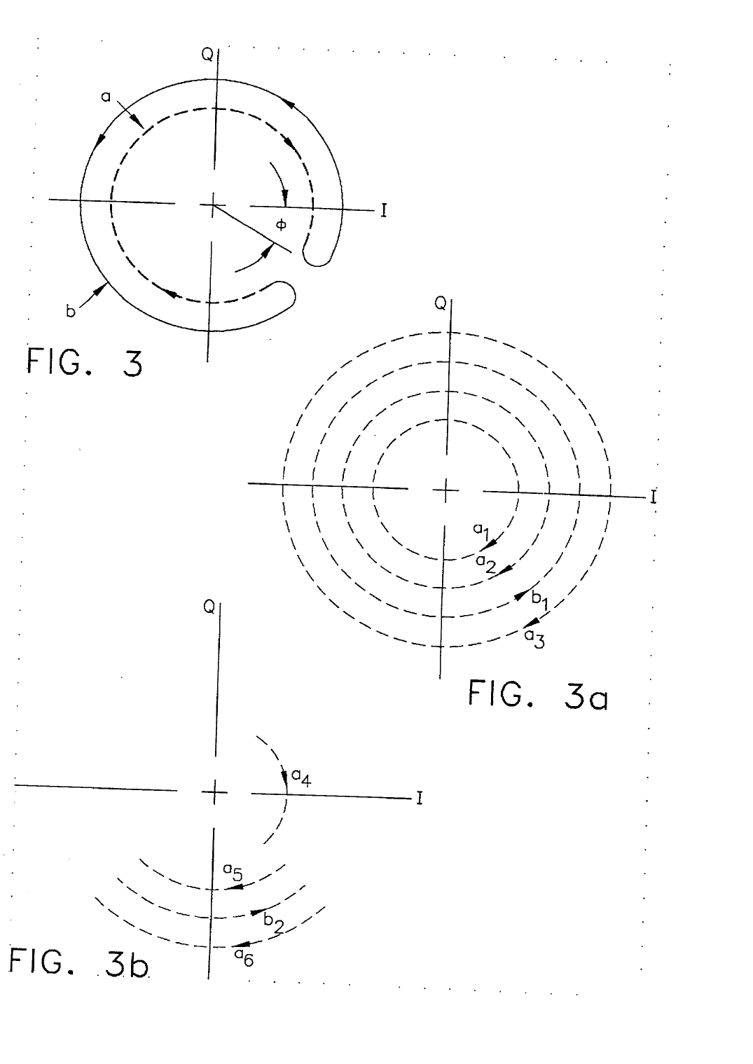

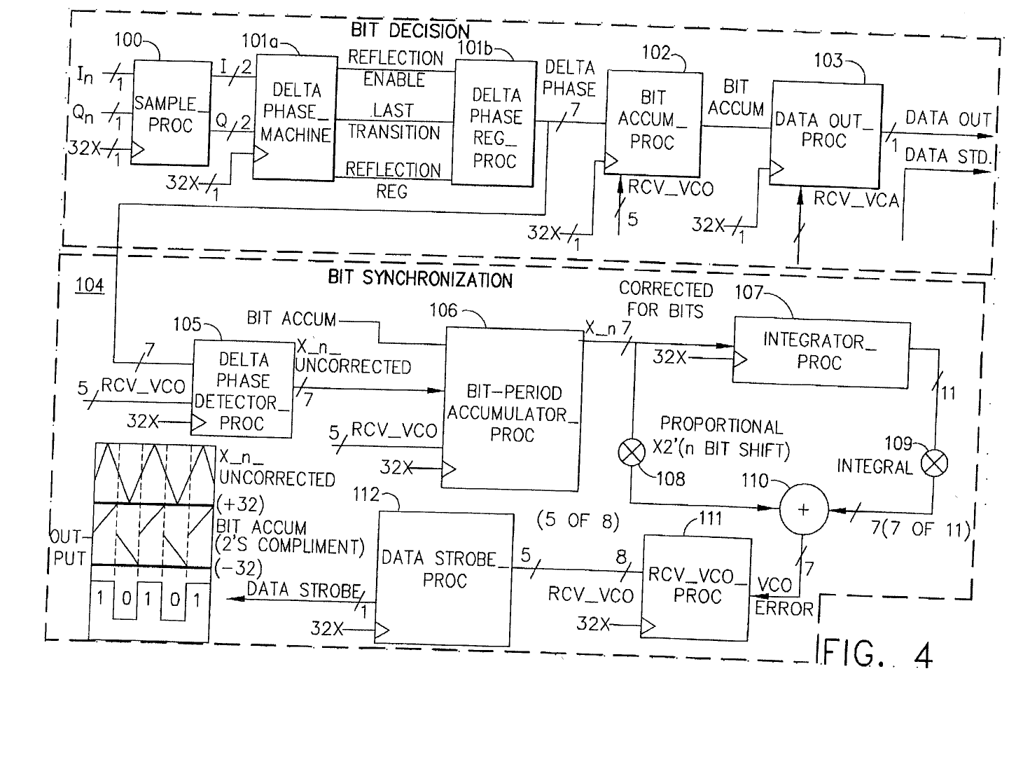

It will be understood that the outputs of comparators 13 and 14 are another ordered pair of numbers. This hard-limited (i.e., either a +1 or −1) ordered pair identifies the quadrant in which the original complex I-Q data pair resides. It will be observed that this mapping of complex I-Q data points to quadrant identifiers is both unique and one-to-one. For this reason, it has been found that this mapping can be used to detect the presence of demodulated data symbols. This mapping is summarized in Table 1 and FIG. 3.

In FIG. 3, the logical 1 bit trajectory (which proceeds in a clockwise direction and extends over a nominal length of 2π radians, for example) is depicted as dashed path a, while the logical 0 bit trajectory (which proceeds in a counterclockwise direction and extends over a nominal length of 2π radians, for example) is depicted as dotted path b. It will be noted that the relative amplitudes of trajectories a and b have been distorted for clarity in FIG. 3. The arbitrary phase angle φ defines the instantaneous orientation of the trajectories. In the first embodiment as will be described in more detail hereinafter and without limiting the present invention, a logical 1 data symbol is defined by a 2π excursion of the trajectory in the clockwise direction, while a logical 0 data symbol is defined by a 2π excursion of the trajectory in the counterclockwise direction. This will be referred to herein as “2π modulation.” Accordingly, one of the features of the present invention is the ability to associate a particular data symbol with a particular direction of travel of the trajectory of the signal in the complex plane. For example, a logical 1 data symbol is associated with a clockwise excursion of the trajectory, while a logical 0 data symbol is associated with a counterclockwise excursion of the trajectory. This approach eliminates the necessity of calculating the magnitude of a particular phase angle θ at a given moment in time, for example through the relationship θ=tan⁻¹(I/Q).

In a second embodiment of the present invention, a logical 1 data symbol is defined more generally by a π/n excursion of the trajectory in one direction, while a logical 0 data symbol is defined by a π/n excursion of the trajectory in the opposite direction, where n may represent any positive number. This will be referred to herein as “π/n modulation”.

Accordingly, a particular series of digital data symbols, such as 1101, for example, may be represented as illustrated in FIG. 3a (where n=0.5, i.e., 2π modulation) as a first circular trajectory excursion a₁ of 2π in the clockwise direction representing a logical 1, a second circular trajectory excursion a₂ of 2π in the clockwise direction representing a logical 1, a third circular trajectory excursion b₁ of 2π in the counterclockwise direction representing a logical 0, and a fourth circular trajectory excursion a₃ of 2π in the clockwise direction representing a logical 1. It will be understood that each subsequent excursion generally originates from the ending point of the previous excursion, and that as depicted in FIG. 3a, the amplitudes of each of the excursions has been distorted for clarity.

The mapping of the outputs from comparators 13 and 14 with particular quadrants in the complex plane is illustrated in Table 1. For example, in the exemplary embodiment illustrated, if the I signal from linear vector demodulator 10 is −1 and the Q signal from linear vector demodulator 10 is −1, the I output from comparator 13 will be 0 and the Q output from comparator 14 will be 0. This places that particular ordered pair in quadrant 3 as illustrated in FIG. 1. It will be understood that the remaining combinations of I and Q signals also correspond uniquely to ordered pairs in specific quadrants as illustrated in FIG. 1 and Table 1.

TABLE 1

| I | Q | Iₙ | Qₙ | Quadrant |
|---|---|---|---|---|
| −1 | −1 | 0 | 0 | 3 |
| −1 | +1 | 0 | 1 | 2 |
| +1 | −1 | 1 | 0 | 4 |
| +1 | +1 | 1 | 1 | 1 |

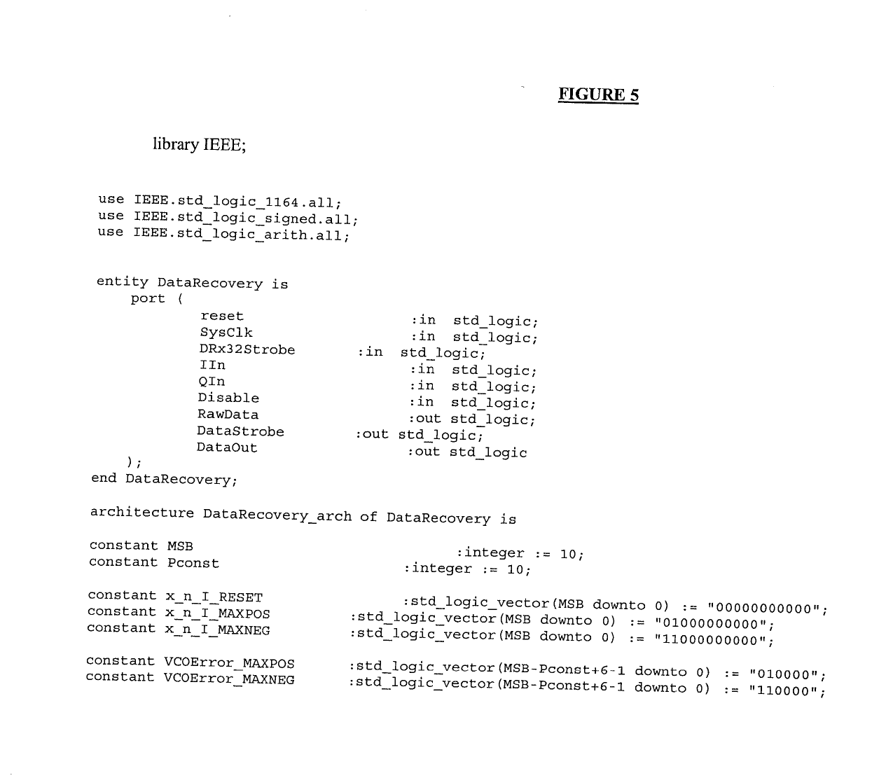

The respective outputs Iₙ and Qₙ from comparators 13 and 14 are applied to the inputs of signal processor 15 as shown in FIG. 1 and FIG. 4. It will be understood that signal processor may be implemented in the form of digital logic according to the VHDL code illustrated in FIG. 5, which has been depicted in generalized block diagram form in FIG. 4. In an exemplary embodiment, the present invention was implemented in a XILINX FPGA. The function of the signal processor in this embodiment is to determine the direction and extent of 2π trajectory excursions representative of the digital data symbols.

As shown in the exemplary embodiment of FIG. 4, the respective outputs Iₙ and Qₙ are applied to the Sample_proc 100. The Sample_proc 100 receives the raw Iₙ and Qₙ samples and latches consecutive samples Iₙ and Iₙ₋₁ and Qₙ and Qₙ₋₁ to form coded two bit outputs I and Q.

The I and Q outputs are applied to a decoder comprising two VHDL processes: DeltaPhaseMachine 101a, and DeltaPhaseReg_proc 101b. DeltaPhaseMachine 101a is a state machine with five states: idle, CW, CCW, Steady1, and Steady2. DeltaPhaseMachine 101a has three outputs: ReflectionEnable, Last Transition and a 16-bit shift register, ReflectionReg. Initially, DeltaPhaseMachine 101a is in the idle state. Reflection enable is false and ReflectionReg is zeroed. I and Q inputs are decoded to detect a quadrant change. Upon detection of a quadrant change, the state machine transitions to state CW for a clockwise change or to CCW for a counter-clockwise change. At this time LastTransition is loaded with the value of the detected change: ‘0’ for CW, and ‘1’ for CCW. ReflectionReg is loaded with ‘1’ as its LSB.

In the present state I and Q inputs are decoded. If a quadrant change is detected the state machine will transition to CW or CCW as previously described. If no transition is detected the machine will transition to Steady1. In Steady1, I and Q inputs are decoded. If a quadrant change is detected the state machine will transition to CW or CCW as appropriate. On this transition a comparison is made between the presently detected quadrant change and LastTransition. If the presently detected transition differs from the LastTransition, a direction change either from CW to CCW or vice versa is indicated. In this case ReflectionEnable is set to TRUE. If no transition is detected, DeltaPhaseMachine 101a transitions to Steady2.

From Steady2 I and Q inputs are decoded. If a quadrant change is detected operation will be the same as for state Steady1. If no change is detected DeltaPhaseMachine 101a will transition to Steady1. Simultaneously with this event a ‘1’ is shifted into the LSB of ReflectionReg and all previous bits similarly shifted up. This action serves to enter a ‘1’ bit into the ReflectionReg every two sampling periods.

DeltaPhaseReg_proc 101b is a 16-bit modified shift register called DeltaPhaseReg. For the simple case, where a quadrant change occurs on a bit boundary, ReflectionEnable is false and bits in the register will be shifted normally with the LSB position loaded with the LastTransition value, i.e., a ‘1’ for a CCW quadrant change or a ‘0’ for a CCW change. For the case in which the bit boundary falls within a quadrant ReflectionEnable is true. With this condition bits 0 through 15 of the 16-bit register are exclusive-or'ed with ReflectionReg to produce the shifted bits. This action inverts those DeltaPhaseReg bits which have logical ‘1’s in their corresponding ReflectionReg bits. Since ReflectionReg has shifted a logical ‘1’ in for every two samples periods between a CW-to-CCW change or a CCW-to-CW change, half of the samples taken during this period will be inverted and thus their value will be attributed to the successive bit rather than to the former. Bit 16 of DeltaPhaseReg is used to produce a 7 bit 2's complement sample DeltaPhase that equals +1 for DeltaPhaseReg bit 16 at logical ‘1’ and −1 for logical ‘0’.

The DeltaPhase output from DeltaPhaseReg_proc 101b is applied to BitAccum_proc 102. BitAccum_proc 102 accumulates the DeltaPhase output over a one bit period, which is defined by the five bit RCV_VCO feedback signal from the Bit Synchronizer 104, which will be described in more detail later. As will also be described, based on the Bit Synchronizer 104 operation, the RCV_VCO signal, upon achieving a value of 00000 in BitAccum_proc 102, will produce a new bit period that will reset BitAccum_proc 102 to a new bit period. Accordingly, BitAccum_proc 102 will accumulate a new set of values from that point on based on receiving the RCV_VCO feedback signal. Upon that accumulation over a given bit period, BitAccum_proc 102 produces a seven bit result (BitAccum) for consecutive DeltaPhase inputs. However, only one bit of the BitAccum output is of interest at this point, so the seven bit BitAccum output is truncated to a one bit output by ignoring the least significant six bits.

The most significant bit of the BitAccum output is applied to the DataOut_proc 103. DataOut_proc 103 operates to latch the one bit BitAccum sign bit based on the value of the five bit feedback signal RCV_VCO. The DataOut output from DataOut_proc 103 represents the fully demodulated data bit or digital data symbol. Consequently, based on the I and Q inputs and the value of the RCV_VCO feedback signal from the bit synchronizer, the DataOut signal constitutes a demodulated bit decision, and contains the demodulated data symbols.

As illustrated in the exemplary embodiment of FIG. 4, seven bit DeltaPhase signal from DeltaPhase_proc 101 is applied to the DeltaPhaseDetector_proc 105 portion of the group of logic forming Bit Synchronizer 104. DeltaPhaseDetector_proc 105 determines and accumulates how many consecutive zeros and how many consecutive ones are produced by the DeltaPhase signal. This accumulation is expressed by the seven bit x_n_uncorrected result. As illustrated in the VHDL logic of FIG. 5, DeltaPhaseDetector_proc 105 is directed by the RCV_VCO feedback signal to determine the boundaries or bit points of the accumulations carried out by the DeltaPhaseDetector_proc 105.

The operation of DeltaPhaseDetector_proc 105 is also explained in FIG. 5. The Delta Phase output from DeltaPhase_proc 105 is either a 1 or a −1, which should be constant for an entire bit period. Accordingly, as shown in FIG. 5 for a representative bit stream, if Delta Phase is +1, DeltaPhaseDetector_proc 105 adds the DeltaPhase output over half of the bit period and then subtracts the DeltaPhase output over the next half of the bit period. Accordingly, under perfect signal conditions and the system is aligned on the bit, the error signal from DeltaPhaseDetector_proc 105, represented by the x_n_uncorrected result will be zero.

The seven bit x_n_uncorrected signal is applied to BitPeriodAccumulator_proc 106, which is also directed by the RCV_VCO signal. BitPeriodAccumulator_proc 106 produces the seven bit corrected bit sign x_n outputs. This processing assures that the sign of the error is such that the feedback loop will be driven in the proper direction.

These signals are applied to Integrator_proc 107 which is an integrator, the operation of which is well understood in the art. The integral leg 109 produces a 4 bit right shift (i.e., division by a factor of 16) from the integrated result of Integrator_proc 107. For purposes of an exemplary showing, the control loop damping factor ζ, is chosen to be 0.8. However, it will be understood that different values of the damping factor may be chosen to insure stability of the control feedback loop as is well known in the art. Likewise, for purposes of an exemplary showing, the control loop bandwidth is chosen to be 1% of the data rate. However, it will be understood that different values of bandwidth may be chosen depending on the desired speed at which the system attains lock (and dependent on the number of synchronization bits in the preamble of the data packet) as is well known in the art. For purposes of an exemplary showing, a 128 bit synchronization preamble comprising a 1010 . . . pattern at the front of the data packet is provided.

The proportional leg 108 incorporates a no-bit shift factor, i.e., is multiplied by 1. The resulting proportional leg 108 and integral leg 109 are added in summer 110 to produce the 7 bit VCOError result.

The VCOError result is applied to RCV_VCO_proc 111, which includes a counter directed by VCOError to produce a count that is aligned with the bit period of the data. This count represents the eight bit RCV_VCO result which is used as previously described. The least significant 5 bits of RCV_VCO are applied to DataStrobe_int_proc 112, which provides a pulse output DataStrobe when the five least significant bits of RCV_VCO are 11111. For purposes of an exemplary showing, DataStrobe is a 1/32 of a bit pulse that will occur simultaneously with DataOut changing, and is used to synchronize other parts of the system, and, consequently, DataStrobe provides an aligned clock output. The DataStrobe output from DataStrobe_int_proc 112 is aligned with DataOut from DataOut_proc 103.

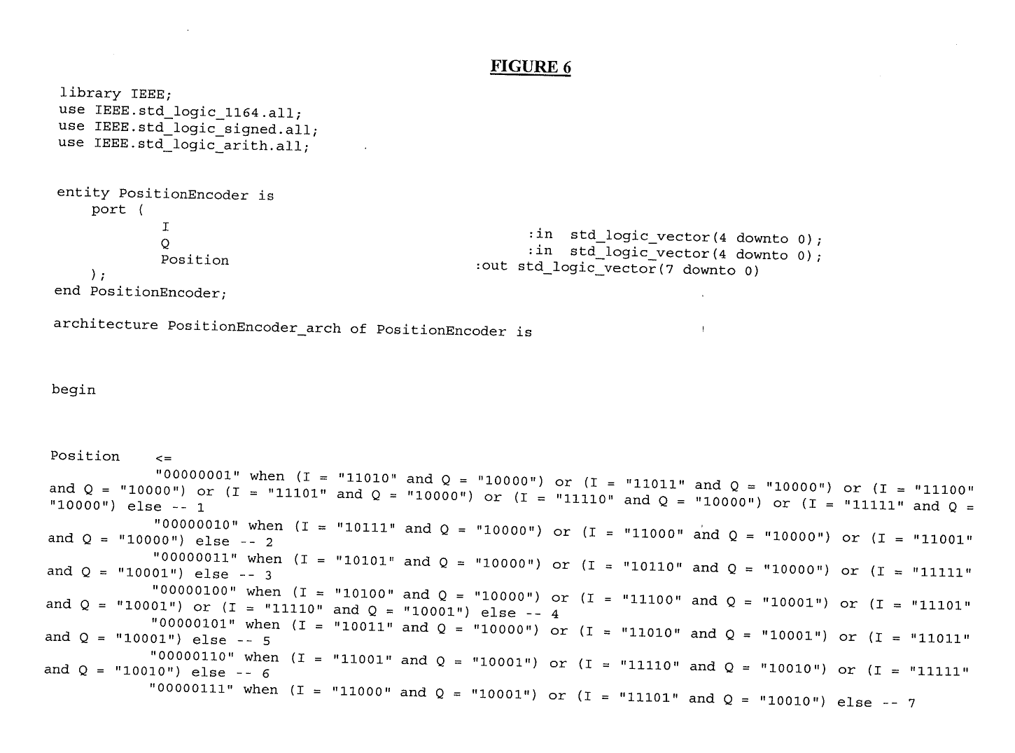

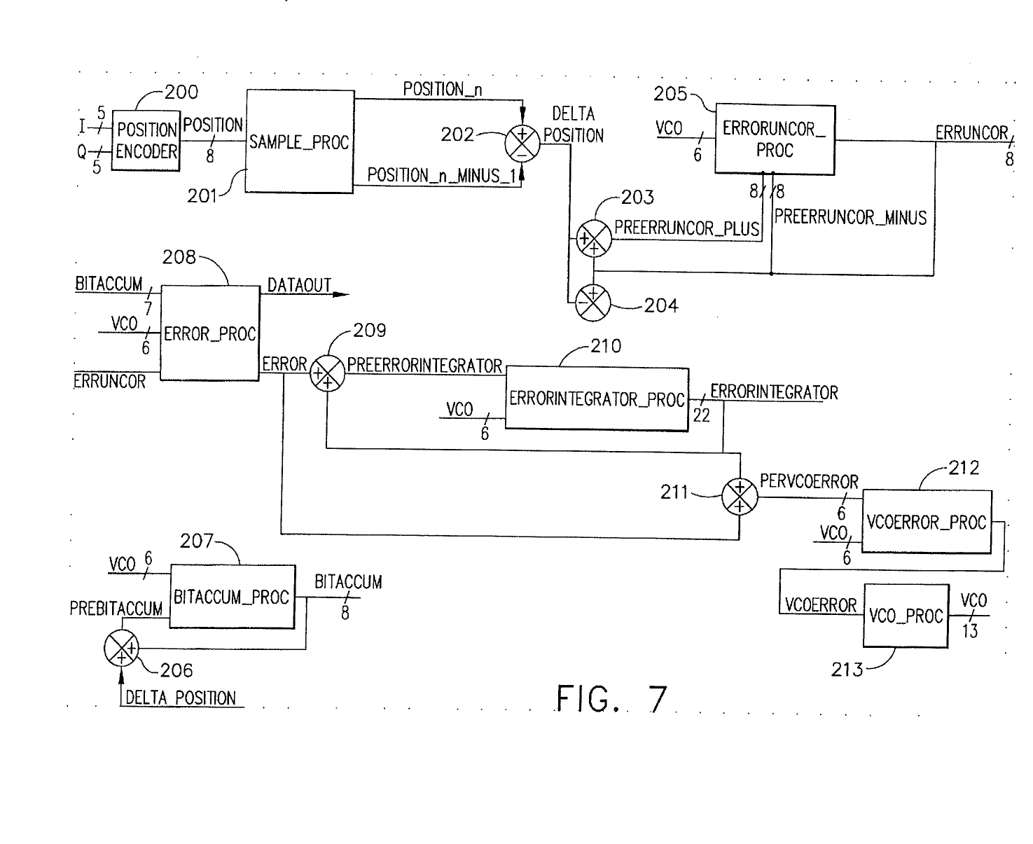

A second embodiment of the present invention is illustrated in FIG. 6-FIG. 7. In this embodiment, interpretation of a particular data symbol is based on a trajectory length of less than a complete circle, rather than a trajectory length of a complete circle of 2π radians (360°) as in the previous embodiment. For example, in this exemplary embodiment, the trajectory length may be expressed as π/n radians, where n is a positive number. Thus, where n=2, the nominal trajectory length is π/2 radians (90°). Accordingly, a clockwise trajectory of nominally π/2 radians may be interpreted, for example, as digital 1 data symbols, and a counterclockwise nominal trajectory length of π/2 radians may be interpreted as logical 0 data symbols. While these assignments have been made for purposes of an exemplary showing, it will be understood that a clockwise trajectory may be interpreted as a logical 0 data symbol and a counterclockwise trajectory interpreted as a logical 1 data symbol. Similarly, other values of n may be chosen for the trajectory length, for example n=1 (π radians or 180° trajectory length), n=3 (π/3 radians or 60° trajectory length), n=4 (π/4 radians or 45° trajectory length), etc. Further, n may be chosen to be a non-integer, so that the trajectory length may be any length desired. And the trajectory lengths may be chosen to be unequal, for example a logical 1 data symbol may be chosen to have a different trajectory length from a logical 0 data symbol, or the trajectory length may vary depending on the transmitted signal power or some other parameter.

Accordingly, in this example of π/n modulation (where n=2), a series of digital data symbols, for example 1101, may be represented as illustrated in FIG. 3b as a first circular trajectory excursion a₄ of π/2 in the clockwise direction representing a logical 1, a second circular trajectory excursion a₅ of π/2 in the clockwise direction representing a logical 1, a third circular trajectory excursion b₂ of π/2 in the counterclockwise direction representing a logical 0, and a fourth circular trajectory excursion a₆ of π/2 in the clockwise direction representing a logical 1. It will be understood that the starting point for the data symbol series is arbitrary, and that each of these excursions may or may not be of the same length. Further, as depicted in FIG. 3a and FIG. 3b, the amplitudes of each of the trajectory excursions has been distorted for clarity, since in general, the amplitude of a particular trajectory excursion will be a function of the power associated with that data symbol. Thus, the change in the phase angles of the two trajectory excursions may both be π/2 radians, but the path lengths of the two excursions may be different because their associated powers are different.

Based on the previous explanation and the description that follows, it will be understood that decreasing the length of the signal trajectory permits a determination of a particular data symbol to be made with a smaller phase excursion, thereby defining phase segments as short as desired, and consequently requiring less bandwidth.

In the second exemplary embodiment of the present invention under discussion, comparators 13 and 14 have been replaced with multi-bit A/D converters. Accordingly, the A/D converters 13 and 14 provide for better resolution of the trajectory, since they allow multiple levels of amplitude. This multiple encoding of amplitude allows the actual trajectory to be defined with more precision than in the previous embodiment, since individual points can be resolved on the trajectory, rather than merely identification of a particular quadrant.

As illustrated in FIG. 7, the five bit I and Q signals from A/D converters 13 and 14, respectively, and which represent the position on the complex plane signal trajectory, are applied to PositionEncoder 200. Position Encoder 200 represents a look-up table which receives the position I and Q signals and converts that position to an eight bit word output, designated Position. In the exemplary embodiment shown, the position on the signal trajectory is divided into 255 increments. Hence, for example in the π/2 case, 0° is represented by a 0 position, 90° by the 64 position, 180° by the 128 position, and 270° by the 192 position. In this exemplary embodiment, this provides a sufficient number of positions around the trajectory circle for the regional precision for the π/2 implementation under discussion. However, it will be understood that greater precision can be obtained by utilizing more bits from each of A/D converters 13 and 14 in order to provide more positions around the trajectory circle. This I and Q sample information determines where the signal is on the trajectory.

The Position word is applied to Sample_Proc 201, which takes 32 samples per bit to derive two signals: Position_n, which represents the current sampled position on the signal trajectory, and Position_n_minus_{—}1, which represents the previously sampled position on the trajectory.

The Position_n and Position_n_minus_{—}1 signals are subtracted in subtracter 202 to form the DeltaPosition signal, which is representative of the change in phase angle of the trajectory that has occurred between the two consecutive samples, as well as the direction of travel of the trajectory.

The DeltaPosition signal is applied to a first summer 203 which adds the DeltaPosition signal to the ErrUncor signal (to be described) to produce the eight bit preErrUncor_plus signal. The other summer 204 subtracts the DeltaPostion and ErrUncor signals to produce the eight bit preErrUncor_minus signal. The ErrorUncor_proc 205, under control of the VCO signal (to be described), accumulates the preErrUncor_plus signals for the first 16 samples and thereafter accumulates the preErrUncor_minus signals for the next 16 samples. The result of this accumulation is the eight bit ErrUncor error signal, which will be zero if the bits are synchronized over a bit period.

As also illustrated in FIG. 7, The DeltaPosition signal is added to the BitAccum signal (to be described) in a summer 206 to produce the prebitAccum signal. The prebitAccum signal is applied to BitAccum_proc 207 together with the VCO signal. Bit Accum_proc 207 accumulates the DeltaPosition signal over one bit period (32 samples) to obtain the 8 bit BitAccum signal.

This signal is applied to Error_proc 208 which, under control of the VCO signal, utilizes the MSB of the BitAccum signal to determine if ErrUncor should be inverted. In the exemplary embodiment shown, if the MSB of BitAccum is a logical 1, the Error signal is the same as the ErrUncor signal. If the MSB of BitAccum is a logical 0, the Error signal is the 2's complement of the ErrUncor signal. Hence, the Error signal provides a closed loop error signal for driving the bit synchronization circuit as described below. In addition, the inverse of the MSB of the BitAccum word forms the DataOut signal which represents the fully demodulated data bit or digital data symbol.

The Error signal is added in summer 209 to the ErrorIntegrator signal (to be described) to produce the preErrorIntegrator signal. The preErrorlntegrator signal is applied to an integrator designated Errorlntegrator_proc 210, under control of the VCO signal, which integrates the Error signal over time in order to nullify any frequency errors that may occur between the internal bit rate and the bit rate associated with the original modulated signal. The 22 bit integral ErrorIntegrator signal is applied to summer 209 as previously described and to a summer 211, together with the proportional Error signal. The two signals applied to summer 211 represent integral and proportional paths, respectively, which are added together to form the six bit preVCOError signal.

The preVCOError signal is applied to VCOError_proc 212, which samples the preVCOError signal every bit period to produce the VCOError signal which functions as a control signal to the subsequent circuitry forming a voltage controlled oscillator.

The VCOError signal is applied to VCO_proc 213 which functions as a counter. In the exemplary embodiment described, if the VCOError signal is a 0, the VCO_proc 213 counter counts down at the sampling rate from 31 to 0, which represents one data bit period. If the VCOError signal is a 1, the VCO_proc 213 counter counts down from 32 to 0 to define one data bit period. The output, represented by the 13 bit VCO signal, is applied as a synchronization signal to other blocks as previously described. Accordingly, a negative VCOError signal will cause a shorter data bit period to speed up the system, i.e., increase the internal bit rate to match that of the original modulated bit rate, while a positive VCOError signal will cause a longer data bit period to slow the system down, i.e., decrease the internal bit rate to match that of the original modulated bit rate.

Accordingly, these circuits operate as a bit synchronizer to synchronize the internal bit rate to that of the original modulated signal so that bit samples may be synchronized to the expected modulated trajectory length by recovering the clock from the modulated bit stream. It will be observed that in the second exemplary embodiment described, this is accomplished by modifying the bit synchronizer described in connection with the embodiment of FIG. 4 to take more precise samples; i.e., the bit synchronizer of the embodiment of FIG. 4 essentially utilizes a one bit A/D converter through the outputs from comparators 13 and 14 for 2π modulation, while the embodiment of FIG. 7 using π/n requires multiple-bit samples from A/D converters 13 and 14. Accordingly, the bit synchronizer can be simplified because the location of the trajectory path within a quadrant can be more accurately determined in the π/n modulation embodiment described. It will be understood, however, that other forms of bit synchronization may be used in connection with the demodulation scheme of the present invention.

Having describe exemplary embodiments of our invention, we claim:

1. A method of demodulating a modulated signal containing digital data symbols comprising:
a) establishing a complex trajectory of the modulated signal; and
b) interpreting said complex trajectory of the modulated signal as said digital data symbols.

2. The method according to claim 1 wherein said trajectory is established by determining the direction of the trajectory.

3. The method according to claim 2 wherein the direction of the trajectory in one direction is interpreted as a logical 1 and the direction of the trajectory in the opposite direction is interpreted as a logical 0.

4. The method according to claim 3 wherein a trajectory in a clockwise direction is interpreted as a logical 1 and a trajectory in a counterclockwise direction is interpreted as a logical 0.

5. The method according to claim 2 wherein the trajectory traverses at least 2π radians.

6. The method according to claim 2 wherein the trajectory traverses less than 2π radians.

7. The method according to claim 1 wherein a trajectory of less than a full circle in one direction is interpreted as a logical 1 and a trajectory of less than a full circle in the opposite direction is interpreted as a logical 0.

8. The method according to claim 1 wherein a trajectory of π/n radians in one direction is interpreted as a logical 1 and a trajectory of π/n radians in the opposite direction is interpreted as a logical 0, where n equals any number.

9. The method according to claim 8 wherein n=0.5.

10. The method according to claim 8 wherein n=2.

11. The method according to claim 1 wherein the modulated signal uses 2π modulation.

12. The method according to claim 1 wherein the modulated signal uses π/n modulation.

13. The method according to claim 12 wherein n=2.

14. The method according to claim 1 wherein the trajectory traverses π/2 radians; and a trajectory in a clockwise direction is interpreted as a logical 1 and a trajectory in a counterclockwise direction is interpreted as a logical 0.

15. A method of demodulating a radio signal modulated with digital data symbols comprising:
a) producing at least one in-phase (I) and quadrature (Q) pair from said signal; and
b) interpreting said I and Q pair to detect said data symbols.

16. The method according to claim 15 wherein the presence of demodulated data signals is determined at least in part by interpreting the quadrant in which said pair resides.

17. A method of demodulating a radio signal modulated with digital data symbols comprising:
a) establishing the trajectory of the modulated signal in the complex plane;
b) determining a first point on said trajectory at a first time;
c) determining a second point on said trajectory at a second time later than said first time;
d) comparing said first and second points;
e) interpreting the difference in said points as a digital data symbol.

18. The method according to claim 17 including:
a) associating a value with each of said points;
b) subtracting said values to produce a difference value; and
c) interpreting a positive difference value as a first digital data symbol and a negative difference value as a digital data symbol different from said first digital data symbol.

19. The method according to claim 18 wherein a positive difference value represents a logical 1 data symbol and a negative difference value represents a logical 0 data symbol.

20. The method according to claim 19 wherein the trajectory is 2π radians in length.

21. The method according to claim 19 wherein the trajectory is π/2 radians in length.

22. A system for extracting digital data symbols from a modulated signal comprising:
a) a demodulator producing at least one in-phase (I) and quadrature (Q) pair from said signal; and
b) a signal processor for interpreting said at least one I and Q pair to detect said digital data symbols.

23. The system according to claim 22 wherein said signal processor operates to detect the presence of the digital data symbols by establishing a complex trajectory of the modulated signal and by interpreting said trajectory of the modulated signal as said digital data symbols.

24. The system according to claim 23 wherein said data symbols are established by determining the direction of the trajectory.

25. The system according to claim 24 wherein the direction of the trajectory in one direction is interpreted as a logical 1 and the direction of the trajectory in the opposite direction is interpreted as a logical 0.

26. The system according to claim 25 wherein a trajectory in a clockwise direction is interpreted as a logical 1 and a trajectory in a counterclockwise direction is interpreted as a logical 0.

27. The system according to claim 24 wherein the trajectory traverses at least 2π radians.

28. The system according to claim 24 wherein the trajectory traverses less than 2π radians.

29. The system according to claim 24 wherein a trajectory of less than a full circle in one direction is interpreted as a logical 1 and a trajectory of less than a full circle in the opposite direction is interpreted as a logical 0.

30. The system according to claim 24 wherein a trajectory of π/n radians in one direction is interpreted as a logical 1 and a trajectory of π/n radians in the opposite direction is interpreted as a logical 0, where n equals any number.

31. The system according to claim 30 wherein n=0.5.

32. The system according to claim 30 wherein n=2.

33. The system according to claim 22 wherein the modulated signal uses 2π modulation.

34. The system according to claim 22 wherein the modulated signal uses π/n modulation.

35. The system according to claim 34 wherein n=2.

36. The system according to claim 24 wherein the trajectory traverses n/2 radians; and a trajectory in a clockwise direction is interpreted as a logical 1 and a trajectory in a counterclockwise direction is interpreted as a logical 0.

37. The system according to claim 22 wherein the presence of demodulated data signals is determined at least in part by interpreting the quadrant in which said pair resides.

38. A system for demodulating a radio signal modulated with digital data symbols comprising:
a) a demodulator establishing a trajectory of the modulated signal in the complex plane; and
b) a signal processor, said signal processor being operable to:
i) determine a first point on said trajectory at a first time;
ii) determine a second point on said trajectory at a second time later than said first time;
iii) compare said first and second points; and
iv) interpret the difference in said points as a digital data symbol.

39. The system according to claim 38 wherein said processor is operable to:
i) associate a value with each of said points;
ii) subtract said values to produce a difference value; and
iii) interpret a positive difference value as a first digital data symbol and a negative difference value as a digital data symbol different from said first digital data symbol.

40. The system according to claim 39 wherein a positive difference value represents a logical 1 data symbol and a negative difference value represents a logical 0 data symbol.

41. The system according to claim 38 wherein the trajectory is 2π radians in length.

42. The system according to claim 38 wherein the trajectory is π/2 radians in length.

43. A demodulation system for demodulating a digital radio signal with digital data symbols comprising:
a) a demodulator producing an in-phase (I) and quadrature (Q) pair from said signal; and
b) a signal processor for interpreting said I and Q pair to detect the digital data symbols.

44. The system according to claim 43 wherein said signal processor operates to detect the presence of the digital data symbols by establishing a complex trajectory of the modulated signal and by interpreting said trajectory of the modulated signal as said digital data symbols.

45. The system according to claim 44 wherein said data symbols are established by determining the direction of the trajectory.

46. The system according to claim 45 wherein the direction of the trajectory in one direction is interpreted as a logical 1 and the direction of the trajectory in the opposite direction is interpreted as a logical 0.

47. The system according to claim 46 wherein a trajectory in a clockwise direction is interpreted as a logical 1 and a trajectory in a counterclockwise direction is interpreted as a logical 0.

48. The system according to claim 43 wherein the presence of demodulated data signals is determined at least in part by interpreting the quadrant in which said pair resides.

49. A wireless receiver comprising:
a) an antenna for receiving radio signals modulated with digital data symbols;
b) a demodulator connected to said antenna for producing from said signal an in-phase (I) and quadrature (Q) pair;
c) a signal processor for determining the direction of the trajectory of said in-phase (I) and quadrature (Q) pair and for associating a predetermined direction of the trajectory as a associated with a digital data symbol; and
d) a circuit for outputting the digital data symbols.

50. The system according to claim 49 wherein the direction of the trajectory in one direction is interpreted as a logical 1 and the direction of the trajectory in the opposite direction is interpreted as a logical 0.

51. The system according to claim 50 wherein a trajectory in a clockwise direction is interpreted as a logical 1 and a trajectory in a counterclockwise direction is interpreted as a logical 0.

52. The system according to claim 49 wherein the presence of demodulated data signals is determined at least in part by interpreting the quadrant in which said pair resides.

53. The receiver according to claim 49 wherein the modulated radio signals are FSK-type modulated signals.

54. The receiver according to claim 49 wherein said demodulator comprises a linear vector demodulator.

55. The receiver according to claim 49 wherein the demodulator is non-coherent.

56. A wireless receiver comprising:
a) an antenna for receiving radio signals modulated with digital data symbols;
b) a demodulator connected to said antenna for producing from said signal an in-phase (I) and quadrature (Q) pair;
c) a signal processor for interpreting said I and Q pair to detect said digital data symbols; and
d) a circuit for outputting the digital data signals.

57. The receiver according to claim 56 wherein said signal processor operates to detect the presence of the digital data symbols by establishing a complex trajectory of the modulated signal and by interpreting said trajectory of the modulated signal as said digital data symbols.

58. The receiver according to claim 57 wherein said trajectory is established by determining the direction of the trajectory.

59. The receiver according to claim 58 wherein the direction of the trajectory in one direction is interpreted as a logical 1 and the direction of the trajectory in the opposite direction is interpreted as a logical 0.

60. The receiver according to claim 59 wherein a trajectory in a clockwise direction is interpreted as a logical 1 and a trajectory in a counterclockwise direction is interpreted as a logical 0.

61. The receiver according to claim 56 wherein the presence of demodulated data signals is determined at least in part by interpreting the quadrant in which said pair resides.

62. The receiver according to claim 56 wherein the modulated radio signals are FSK-type modulated signals.

63. The receiver according to claim 56 wherein said demodulator comprises a linear vector demodulator.

64. The receiver according to claim 56 wherein the demodulator is non-coherent.

65. A wireless receiver comprising:
a) an antenna for receiving radio signals modulated with digital data symbols;
b) a demodulator connected to said antenna for establishing a trajectory of the modulated signal in the complex plane; and
c) a signal processor, said signal processor being operable to:
i) determine a first point on said trajectory at a first time;
ii) determine a second point on said trajectory at a second time later than said first time;
iii) compare said first and second points; and
iv) interpret the difference in said points as a digital data symbol.

66. The receiver according to claim 65 wherein said processor is operable to:
i) associate a value with each of said points;
ii) subtract said values to produce a difference value; and
iii) interpret a positive difference value as a first digital data symbol and a negative difference value as a digital data symbol different from said first digital data symbol.

67. A system for demodulating signals modulated with data symbols comprising:
a) means for defining the modulated signal as a trajectory in the complex plane;
b) means for sampling a plurality of points on said trajectory;
c) means for comparing said points; and
d) means for interpreting the results of said comparison as the data symbols.

68. The system according to claim 67 wherein the length on the trajectory is 2π radians.

69. The system according to claim 67 wherein the length of the trajectory is π/2 radians.

70. The system according to claim 67 wherein
i) said sampling means determines a first point on said trajectory at a first time and a second point on said trajectory at a second time later than said first time;
ii) said comparing means compares said first and second points; and
iii) said interpreting means interprets the difference in said points as a digital data symbols.

71. The system according to claim 70 wherein:
i) said sampling means associates a value with each of said points;
ii) said comparing means subtracts said values to produce a difference value; and
iii) said interpreting means interprets a positive difference value as a first digital data symbol and a negative difference value as a digital data symbol different from said first digital data symbol.

72. The system according to claim 71 wherein a positive difference value represents a logical 1 data symbol and a negative difference value represents a logical 0 data symbol.
